(19) United States
(12) Patent Application Publication
(10) Pub. No.: US 2022/0248509 A1
(43) Pub. Date: Aug. 4, 2022

(54) SYSTEMS AND METHODS FOR DISPLAYING TIME TO TEMPERATURE IN MICROWAVE APPLIANCES

(71) Applicant: Haier US Appliance Solutions, Inc., Wilmington, DE (US)

(72) Inventors: Patrick Glen Hall, Louisville, KY (US); Ryan Newquist, Louisville, KY (US)

(21) Appl. No.: 17/163,651

(22) Filed: Feb. 1, 2021

(51) Int. Cl. H05B 6/64; H05B 6/68

(52) U.S. Cl. CPC H05B 6/6455; H05B 6/687; H05B 6/6438

(57) ABSTRACT

A method of displaying time to temperature for a microwave appliance includes operating the microwave appliance to heat an article positioned within a cooking chamber of the microwave appliance, measuring a temperature of the article with an infrared camera of the microwave appliance, calculating an estimated time until the temperature of the article is less than a threshold temperature based at least in part on a cook time input, the measured temperature of the article, and a current power setting of the microwave appliance, and presenting the estimated time on a display of the microwave appliance.

### FIELD OF THE INVENTION

The present subject matter relates generally to microwave appliances and to systems and methods for displaying time to temperature in microwave appliances.

### BACKGROUND OF THE INVENTION

Microwave appliances heat articles (e.g., food or beverages) using electromagnetic radiation. As a result, microwave appliances generally heat an exterior of the articles before an interior of the articles, and the exterior of the articles may be uncomfortable or difficult to handle after heating the interior of the articles to the desired temperature. Accordingly, a microwave appliance with features for assisting a user with handling heated articles would be useful.

### BRIEF DESCRIPTION OF THE INVENTION

Aspects and advantages of the invention will be set forth in part in the following description, or may be apparent from the description, or may be learned through practice of the invention.

In one example embodiment, a method of displaying time to temperature for a microwave appliance includes operating the microwave appliance to heat an article positioned within a cooking chamber of the microwave appliance, measuring a temperature of the article with an infrared camera of the microwave appliance, calculating an estimated time until the temperature of the article is less than a threshold temperature based at least in part on a cook time input, the measured temperature of the article, and a current power setting of the microwave appliance, and presenting the estimated time on a display of the microwave appliance.

In another example embodiment, a microwave appliance includes a cabinet defining a cooking chamber. A user interface panel is positioned on the cabinet. The user interface panel includes a plurality of user inputs and a display. An infrared camera is mounted at the cabinet. The infrared camera is operable to measure a temperature of an article in the cooking chamber of the cabinet. A controller is operably coupled to the user interface panel and the infrared camera. The controller is configured to receive a cook time input from the user interface panel, receive a measured temperature of the article in the cooking chamber from the infrared camera, calculate an estimated time until the temperature of the article in the cooking chamber is less than a threshold temperature based at least in part on the cook time input, the measured temperature of the article in the cooking chamber, and a current power setting of the microwave appliance, and present the estimated time on the display of the user interface panel.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front elevation view of an example microwave appliance positioned above an oven appliance, according to example embodiments of the present disclosure.

FIG. 2 is a schematic view of certain components of the example microwave appliance of FIG. 1.

FIG. 3 is a flow chart of an example method for displaying time to temperature in a microwave appliance, according to example embodiments of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

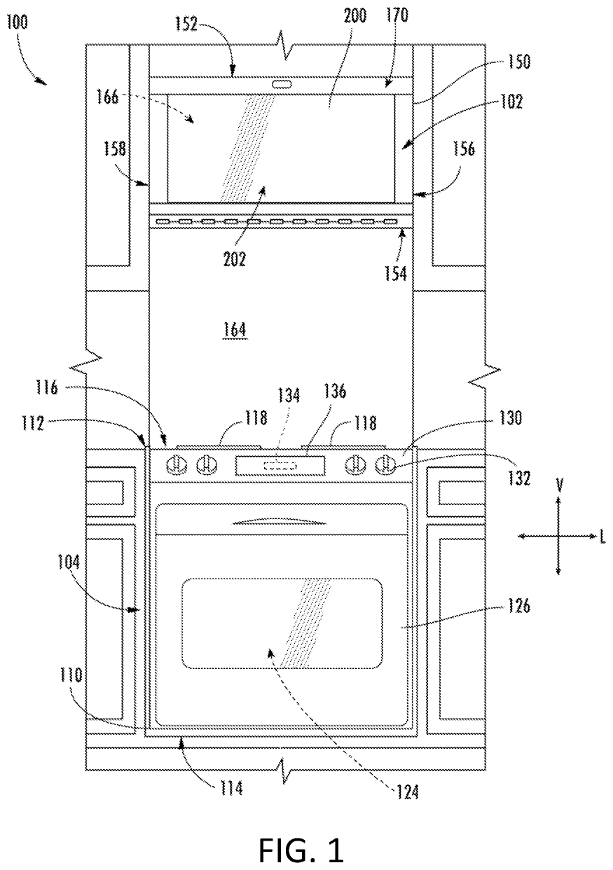

Turning to the figures, FIG. 1 is a front elevation view of a system 100 with an over-the-range (OTR) microwave appliance 102. Microwave appliance 102 can be positioned or mounted above a cooktop appliance 104. It should be appreciated that the present subject matter is not limited to OTR microwave appliances, and the specific appliance configurations are not intended to limit the scope of the present subject matter in any manner. According to alternative example embodiments, the microwave appliance may be a countertop microwave appliance, a drawer-style microwave appliance, etc. As shown in FIG. 1, a vertical direction V and a lateral direction L are perpendicular.

Cooktop appliance 104 can include a chassis or cabinet 110 that extends: along the vertical direction V between a top portion 112 and a bottom portion 114; along the lateral direction L between a left side portion and a right side portion; and along a traverse direction (that is perpendicular to the vertical and transverse directions V, T) between a front portion and a rear portion. Cooktop appliance 104 includes a cooktop surface 116 having one or more heating elements 118 for use in, for example, heating or cooking operations. In exemplary embodiments, cooktop surface 116 is constructed with ceramic glass. In other embodiments, however, cooktop surface 116 may include of another suitable material, such as a metallic material (e.g., steel) or another suitable non-metallic material. Heating elements 118 may be various sizes and may employ any suitable method for heating or cooking an object, such as a cooking utensil, and its contents. In some embodiments, for example, heating element 118 uses a heat transfer method, such as electric coils or gas burners, to heat the cooking utensil. In other embodiments, however, heating element 118 uses an induction heating method to heat the cooking utensil directly. In turn, heating element 118 may include a gas burner element, resistive heat element, radiant heat element, induction element, or another suitable heating element.

In some embodiments, cooktop appliance 104 includes an insulated cabinet 110 that defines a cooking chamber 124 selectively covered by a door 126. One or more heating elements (e.g., top broiling elements or bottom baking elements) may be enclosed within cabinet 110 to heat cooking chamber 124. Heating elements within cooking chamber 124 may be provided as any suitable element for cooking the contents of cooking chamber 124, such as an electric resistive heating element, a gas burner, a microwave element, a halogen element, etc. Thus, cooktop appliance 104 may be referred to as an oven range appliance. As will be understood by those skilled in the art, cooktop appliance 104 is provided by way of example only, and an OTR microwave appliance according to the present subject matter may be used in the context of any suitable cooking appliance, such as a double oven range appliance or a standalone cooktop (e.g., fitted integrally with a surface of a kitchen counter). Thus, the example embodiments illustrated in figures are not intended to limit the present subject matter to any particular cooking chamber or heating element configuration, except as otherwise indicated.

As illustrated, a user interface panel 130 may be provided on cooktop appliance 104. Although shown at front portion of cooktop appliance 104, another suitable location or structure (e.g., a backsplash) for supporting user interface panel 130 may be provided in alternative embodiments. In some embodiments, user interface panel 130 includes input components or controls 132, such as one or more of a variety of electrical, mechanical, or electro-mechanical input devices. Controls 132 may include, for example, rotary dials, knobs, push buttons, and touch pads. A controller 134 is in communication with user interface panel 130 and controls 132 through which a user may select various operational features and modes and monitor progress of cooktop appliance 104. In additional or alternative embodiments, user interface panel 130 includes a display component 136, such as a digital or analog display in communication with a controller 134 and configured to provide operational feedback to a user. In certain embodiments, user interface panel 130 represents a general purpose I/O (“GPIO”) device or functional block.

As shown, controller 134 is communicatively coupled (i.e., in operative communication) with user interface panel 130, controls 132, and display 136. Controller 134 may also be communicatively coupled with various operational components of cooktop appliance 104 as well, such as heating elements (e.g., 118, 128), sensors, etc. Input/output (“I/O”) signals may be routed between controller 134 and the various operational components of cooktop appliance 104. Thus, controller 134 can selectively activate and operate these various components. Various components of cooktop appliance 104 are communicatively coupled with controller 134 via one or more communication lines such as, for example, conductive signal lines, shared communication busses, or wireless communications bands.

In some embodiments, controller 134 includes one or more memory devices and one or more processors. The processors can be any combination of general or special purpose processors, CPUs, or the like that can execute programming instructions or control code associated with operation of cooktop appliance 104. The memory devices (i.e., memory) may represent random access memory such as DRAM or read only memory such as ROM or FLASH. In one embodiment, the processor executes programming instructions stored in memory. The memory may be a separate component from the processor or may be included onboard within the processor. Alternatively, controller 134 may be constructed without using a processor, for example, using a combination of discrete analog or digital logic circuitry (such as switches, amplifiers, integrators, comparators, flip-flops, AND gates, and the like) to perform control functionality instead of relying upon software.

In certain embodiments, controller 134 includes a network interface such that controller 134 can connect to and communicate over one or more networks with one or more network nodes. Controller 134 can also include one or more transmitting, receiving, or transceiving components for transmitting/receiving communications with other devices communicatively coupled with cooktop appliance 104, such as microwave appliance 102. Additionally, or alternatively, one or more transmitting, receiving, or transceiving components can be located off board controller 134. Generally, controller 134 can be positioned in any suitable location throughout cooktop appliance 104. For example, controller 134 may be located proximate user interface panel 130 toward front portion of cooktop appliance 104. In optional embodiments, controller 134 is in operable communication with a controller 134 (described below) of microwave appliance 102 (e.g., through one or more wired or wireless channels).

As noted above, microwave appliance 102 may be positioned or mounted above cooktop appliance 104 (e.g., as an OTR microwave). Specifically, a cabinet 150 of microwave appliance 102 may be positioned above cooktop appliance 104 along the vertical direction V. Cabinet 150 of microwave appliance 102 includes a plurality of outer walls and when assembled, microwave appliance 102 generally extends: along the vertical direction V between a top end 152 and a bottom end 154; along the lateral direction L between a first side end 156 and a second side end 158; and along the transverse direction between a front end and a rear end. In some embodiments, cabinet 150 is spaced apart from cooktop surface 116 along the vertical direction V. An open region 164 may thus be defined along the vertical direction V between cooktop surface 116 and bottom end 154 of cabinet 150. Although a generally rectangular shape is illustrated, any suitable shape or style may be adapted to form the structure of cabinet 150. Within cabinet 150, an internal liner of cabinet 150 defines a cooking chamber 166 for receipt of food items for cooking.

Microwave appliance 102 includes a door assembly 170 that is movably mounted (e.g., rotatably attached) to cabinet 150 in order to permit selective access to cooking chamber 166. Specifically, door assembly 170 can move between an open position (not pictured) and a closed position (e.g., FIG. 1). The open position permits access to cooking chamber 166 while the closed position restricts access to cooking chamber 166. Except as otherwise indicated, with respect to the directions (e.g., the vertical direction V, the lateral direction L, and the transverse direction), the door assembly 170 is described in the closed position. A handle may be mounted to or formed on door assembly 170 to assist a user with opening and closing door assembly 170. As an example, a user can use the handle to open or close door assembly 170 and access or cover cooking chamber 166. Additionally, or alternatively, microwave appliance 102 may include a door release button (not pictured) that disengages or otherwise pushes open door assembly 170 when depressed.

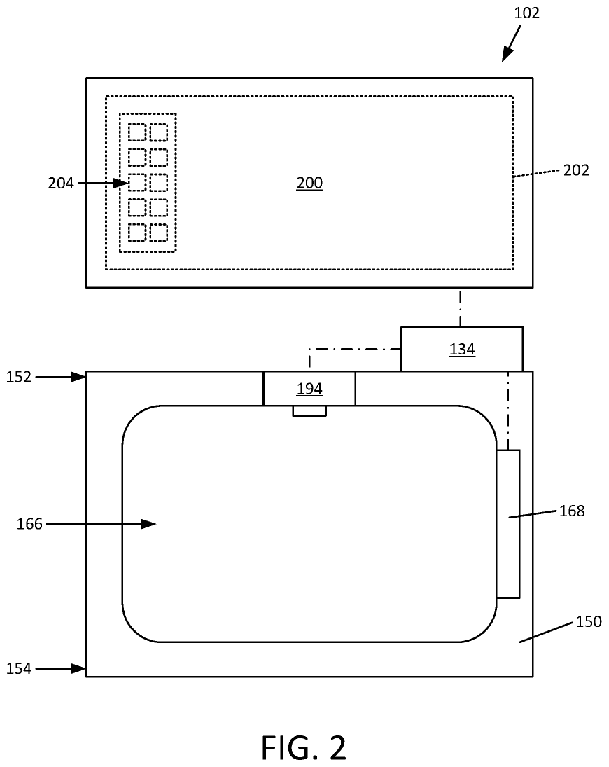

Referring now specifically to FIG. 2, microwave appliance 102 is generally configured to heat articles (e.g., food or beverages) within cooking chamber 166 using electromagnetic radiation. Microwave appliance 102 may include various components which operate to produce the electromagnetic radiation, as is generally understood. For example, microwave appliance 102 may include a heating assembly 168 having a magnetron (e.g., a cavity magnetron), a high voltage transformer, a high voltage capacitor, and a high voltage diode, as is understood. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to cooking chamber 166. The structure and intended function of microwave ovens or appliances are generally understood by those of ordinary skill in the art and are not described in further detail herein.

Microwave appliance 102 may further include an infrared camera 194 that is generally positioned and configured for obtaining images of cooking chamber 166 and/or articles within cooking chamber 166 during operation. Specifically, according to the illustrated embodiment, camera 194 may be mounted proximate top end 152 of cabinet 150 above and/or within cooking chamber 166. Moreover, camera 194 may be mounted such that camera 194 faces downward along the vertical direction V toward cooking chamber 166. In this manner, camera 194 may take images or video of cooking chamber 166 and/or an article within cooking chamber 166. For instance, camera 194 may capture images or video of the article within cooking chamber 166 in the infrared spectrum, and a temperature of the article within cooking chamber 166 may be determined from the images or video of the article within cooking chamber 166 in the infrared spectrum.

Although camera 194 is illustrated as including a single camera 194, it should be appreciated that according to alternative example embodiments, camera 194 may include any suitable number, type, size, and configuration of camera(s) 194 for obtaining infrared images. For example, camera 194 may be a plurality of cameras 194, each camera 194 being positioned for monitoring a respective portion of cooking chamber 166. According still other embodiments, camera 194 may include features for adjusting the field-of-view and/or orientation of camera 194, such that a single camera 194 may be adjusted to monitor the entirety of cooking chamber 166. Notably, controller 134 of microwave appliance 102 (or any other suitable dedicated controller) may be communicatively coupled to camera 194 and may be programmed or configured for analyzing the infrared images obtained by camera 194, e.g., in order to monitor the temperature of an article within cooking chamber 166.

Referring still generally to FIGS. 1 and 2, microwave appliance 102 may include an interactive display assembly 200. According to the illustrated embodiment, interactive display 200 is mounted to or within a door assembly 170 and defines substantially the entire front surface of door assembly 170. In this regard, interactive display 200 extends along substantially the entire width of door assembly 170 along the lateral direction L and substantially along the entire height of door assembly 170 along the vertical direction V.

Generally, interactive display assembly 200 may be any suitable type of mechanism for visually presenting a digital (e.g., interactive) image. For example, interactive display assembly 200 may be an image monitor such as a liquid crystal display (LCD), a plasma display panel (PDP), etc. Thus, interactive display assembly 200 includes an imaging surface 202 (e.g., screen or display panel) at which the digital image is presented or displayed as an optically-viewable picture (e.g., static image or dynamic video) to a user. As illustrated, the imaging surface 202 generally faces, or is directed toward the area forward from the appliance 102 (e.g., when door assembly 170 is in the closed position). During use, a user standing in front of microwave appliance 102 may thus see the optically-viewable picture (e.g., timer, recipe, dynamic video stream, graphical user interface, etc.) displayed at the imaging surface 202.

The optically-viewable picture at the imaging surface 202 may correspond to any suitable signal or data received or stored by microwave appliance 102 (e.g., at controller 134). As an example, image monitor 230 may present recipe information in the form of viewable text or images. As another example, interactive display assembly 200 may present a captured image, such as a live (e.g., real-time) dynamic video stream received from camera 194 or a separate user or device. Thus, e.g., interactive display assembly 200 may present a heat map of cooking chamber 166 and/or an article within cooking chamber 166 from camera 194. As yet another example, interactive display assembly 200 may present a graphical user interface (GUI) 204 (e.g., as part of user interface) that allows a user to select or manipulate various operational features of microwave appliance 102 or cooktop appliance 104. During use of such GUI embodiments, a user may engage, select, or adjust the image presented at interactive display assembly 200 through any suitable input, such as gesture controls detected through camera 194 for, voice controls detected through one or more microphones, associated touch panels (e.g., capacitance or resistance touch panels) or sensors overlaid across imaging surface 202, etc. According to the illustrated embodiment, interactive display assembly 200 is a tablet or touch screen display that extends an entire width and height of door assembly 170 and provides for an interactive experience to the user of microwave appliance 102.

Similar to cooktop appliance 104, microwave appliance 102 may include a controller 134 that facilitates operation of microwave appliance 102. In addition, it should be appreciated that according to exemplary embodiments, in addition to interactive display assembly 200, microwave appliance may further include an additional user interface panel (e.g., similar to user interface panel 130), user inputs (e.g., similar to user inputs 132), a controller (e.g., similar to controller 134), and/or additional displays (such as display 136). Controller 134 may be mounted within cabinet 150, may be mounted within or be a part of interactive display assembly 200, or may be positioned and integrated in any other suitable manner. In some embodiments, cooktop controller 134 is provided as or as part of microwave controller 134. In alternative embodiments, cooktop controller 134 is a discrete unit in selective operable communication with microwave controller 134 (e.g., through one or more wired or wireless channels). A detailed description of such components is omitted here for brevity.

Now that the construction of microwave appliance 102 and camera 194 according to example embodiments have been presented, an example method 300 of displaying time to temperature for a microwave appliance will now be described. While described in greater detail below in the context of microwave appliance 102, it will be understood that method 300 may be implemented in other microwave appliances, such as a countertop microwave appliance, a drawer microwave appliance, etc., in alternative example embodiments.

Method 300 may advantageously provide a user of microwave appliance 102 with an estimated time until an article within cooking chamber 166 is at a temperature suitable for handling by the user. For instance, the article within cooking chamber 166 may increase in temperature during operation of microwave appliance 102 such that the article is uncomfortable and/or difficult to handle due to the temperature of the article. Method 300 may provide the user with the estimated time until the article within cooking chamber 166 is at the temperature suitable for handling by the user such that the user does not handle the article until the article is at such suitable temperature. The various method steps disclosed herein may be performed by controller 134 or a separate, dedicated controller.

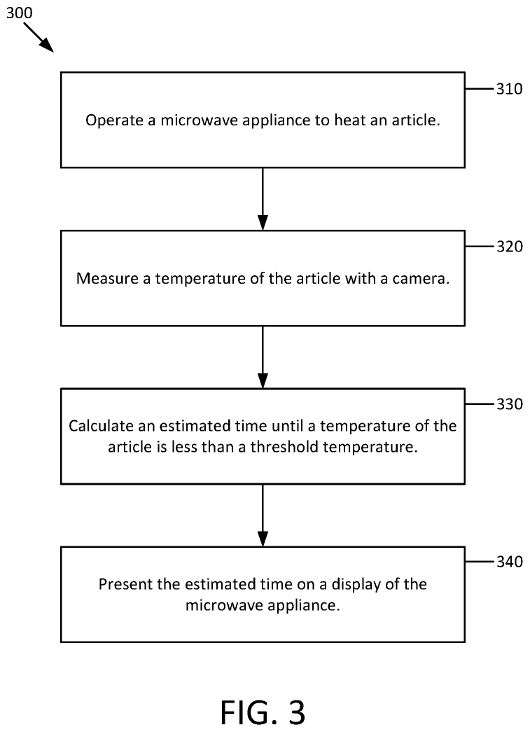

Referring generally to FIG. 3, a method of displaying time to temperature for a microwave appliance is provided. According to example embodiments, method 300 includes, at 310, operating microwave appliance 102 to heat an article within cooking chamber 166. As used herein, the term “article” includes, e.g., cookware, food, beverages, etc., placed within cooking chamber 166 by a user of microwave appliance 100 in order to be heated by electromagnetic radiation during operation of microwave appliance 102. Thus, prior to 310, a user of microwave appliance 102 may place the article within cooking chamber 166. With the article placed within cooking chamber 166, the user may then actuate interactive display assembly 200 or a separate user interface of microwave appliance 102 in order to activate heating assembly 168 such that heating assembly 168 heats the article in cooking chamber 166 with electromagnetic radiation at 310. During 310, the temperature of the article in cooking chamber 166 increases.

At 320, a temperature of the article in cooking chamber 166 is measured, e.g., at various times, such as before, during, and/or after 310. For instance, camera 194 may obtain an infrared image of the article in cooking chamber 166 while the article is heated during 310. As another example, camera 194 may, e.g., also, obtain an infrared image of the article in cooking chamber 166 after the article is heated during 310. Controller 134 may receive the infrared image of the article in cooking chamber 166 from camera 194 and determine the temperature of the article in cooking chamber 166 from the infrared image. As noted above, the temperature of the article in cooking chamber 166 increases during 310. Thus, camera 194 may be used to determine a rate of increase for the temperature of the article in cooking chamber 166 during 310 and/or to measure the temperature of the article in cooking chamber 166 after 310. Although the term “image” is used herein, it should be appreciated that according to example embodiments, camera 194 may take any suitable number or sequence of images, video, or other visual representations of the article within cooking chamber 166, e.g., at 320. These obtained images may vary in number, frequency, angle, resolution, detail, etc. For instance, at 320, camera 194 may be used to measure the temperature of the article in cooking chamber 166 multiple times as the article is heated during 310. Using the multiple temperature measurements, in combination with a duration of 310 and a power output of heating assembly 168 during 310, a heat absorption rate of the article in cooking chamber 166 may be determined. Thus, multiple temperature measurements from camera 194 during 310 may assist with gauging how quickly the article in cooking chamber 166 absorbs heat given the power and time selected for microwave appliance 102. Such feedback may assist with calculating the estimated time described below.

At 330, controller 134 calculates an estimated time until the temperature of the article within cooking chamber 166 is less than a threshold temperature. The estimated time may be calculated based at least in part on a cook time input, the measured temperature of the article from 320, and a current power setting of microwave appliance 102. The estimated time until the temperature of the article within cooking chamber 166 is less than the threshold temperature may be used to determine when the article is suitable for handling by a user. For instance, the user may wait until the estimated time to handle the article within cooking chamber 166 and thereby avoid handling the article at unsuitable temperatures. Thus, the threshold temperature may correspond to a temperature at which the article within cooking chamber 166 may be comfortably handled. As a specific example, the threshold temperature may be no greater than forty-eight degrees Celsius (48° C.) or no greater than one hundred eighteen degrees (118° C.) Fahrenheit. At temperatures less than such specific example temperatures, the article may be comfortably handled by the user.

The cook time input, the measured temperature of the article from 320, and the current power setting of microwave appliance 102 may be used to estimate the specific heat of the article within cooking chamber 166. For instance, controller 134 may include a model for the specific heat of the article within cooking chamber 166 with three inputs: (1) the cook time for 310; (2) the measured temperature of the article from 320; and (3) the power setting of microwave appliance 102 for 310. By modeling the specific heat of the article within cooking chamber 166 with at least these three inputs in combination with an estimate of the heat rejection rate of the article into the ambient air within cooking chamber 166, controller 134 may advantageously calculate the estimated time until the temperature of the article within cooking chamber 166 is less than the threshold temperature.

At 320, an ambient temperature of cooking chamber 166 may also be measured, e.g., at various times, including before, during, and/or after 310. For example, camera 194 may obtain an infrared image of cooking chamber 166 to determine the ambient temperature within cooking chamber 166. At 330, the estimated time may also be calculated based at least in part on the ambient temperature within cooking chamber 166. By also using the ambient temperature within cooking chamber 166, the controller 134 may more accurately calculate the estimated time until the temperature of the article within cooking chamber 166 is less than the threshold temperature. For instance, by incorporating the measured ambient temperature, the specific heat of the article within cooking chamber 166 and/or the heat rejection rate of the article into the ambient air within cooking chamber 166 may be more accurately estimated.

To select the cook time and/or the current power setting, a user may actuate interactive display assembly 200, e.g., one or more inputs on GUI interface 204, or another user interface of microwave appliance 102 prior to 310. Controller 134 may receive the cook time and the current power setting of microwave appliance 102 from interactive display assembly 200 or another user interface of microwave appliance 102, and controller 134 may operate heating assembly 168 at 310 based at least in part on the cook time input and the current power setting of microwave appliance 102. Thus, e.g., prior to 310, the user may select a five (5) minute cook time and a high-power setting, e.g., such that heating assembly 168 heats the article in cooking chamber 166 for five minutes with a power output of about twelve hundred watts (1200 W) during 310. It will be understood that the specific example values for the cook time and power setting provided above are provided by way of example only. Moreover, a user may select specific values for the cook time and power setting depending upon the particular values desired for the article within cooking chamber 166. The cook time and the current power setting of microwave appliance 102 may also be preprogrammed for certain articles, such as popcorn, potatoes, etc., and may be selected by actuating a respective user input. As another example, the cook time and the current power setting of microwave appliance 102 may be sensor controlled, as will be understood by those skilled in the art.

At 340, controller 134 presents the estimated time from 330 on interactive display assembly 200 or another display of microwave appliance 102. Thus, a user may see the estimated time from 330 on interactive display assembly 200 or another display of microwave appliance 102 at 340. Using the estimated time from 330, the user may avoid contacting or picking up the article within cooking chamber 166 until the estimated time arrives. As may be seen from the above, method 300 may provide the user with the estimated time until the article within cooking chamber 166 is at the temperature suitable for handling by the user such that the user does not handle the article until the article is at such suitable temperature.

The estimated time from 330 may be presented in an easily understood format. For instance, the estimated time from 330 may be presented as a countdown timer on interactive display assembly 200 or another display of microwave appliance 102. The countdown timer may correspond to the estimated time until the temperature of the article is less than the threshold temperature. For example, the estimated time from 330 may be two (2) minutes, and interactive display assembly 200 or another display of microwave appliance 102 may display a two-minute countdown timer. When the countdown timer ends, the user may know that the article within cooking chamber 166 is at the temperature suitable for handling. As another example, the estimated time from 330 may be presented as an hourglass, a stopwatch, or another visual format for a timer that informs a viewer of the elapsed period until the estimated time from 330.

Method 300 may also include a feedback loop for the measured temperature of the article in cooking chamber 166. For instance, the temperature of the article within cooking chamber 166 may be measured with camera 194 over time, e.g., after 310. Thus, controller 134 may monitor the temperature of the article within cooking chamber 166 over time with camera 194 after operating microwave appliance 102 to heat the article at 310, and controller 134 may use these measured temperatures to estimate the heat rejection rate and/or update the estimated time from 330. For instance, if the article within cooking chamber 166 cools more quickly than expected, controller 134 may reduce the estimated time from 330. Alternatively, controller 134 may increase the estimated time from 330 if the article within cooking chamber 166 cools more slowly than expected. Thus, the expected time may be calculated, updated, and/or verified based upon feedback temperature data from camera 194.

FIG. 3 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of displaying time to temperature for a microwave appliance, comprising:
operating the microwave appliance to heat an article positioned within a cooking chamber of the microwave appliance;
measuring a temperature of the article with an infrared camera of the microwave appliance;
calculating an estimated time until the temperature of the article is less than a threshold temperature based at least in part on a cook time input, the measured temperature of the article, and a current power setting of the microwave appliance;
and presenting the estimated time on a display of the microwave appliance.

2. The method of claim 1, further comprising selecting the cook time input at a user interface panel of the microwave appliance prior to operating the microwave appliance to heat the article.

3. The method of claim 2, further comprising selecting the current power setting at the user interface panel of the microwave appliance prior to operating the microwave appliance to heat the article.

4. The method of claim 3, wherein a user of the microwave appliance actuates a plurality of inputs on the user interface panel to select the cook time input, to select the current power setting, or to select both the cook time input and the current power setting.

5. The method of claim 1, further comprising measuring an ambient temperature within the cooking chamber with the infrared camera, and wherein calculating the estimated time comprises calculating the estimated time based at least in part on the cook time input, the measured temperature of the article, the current 502506US01/HUSA-1197 power setting of the microwave appliance, and the measured ambient temperature of the cooking chamber.

6. The method of claim 1, wherein the threshold temperature is no greater than forty-eight degrees Celsius or one hundred eighteen degrees Fahrenheit.

7. The method of claim 1, wherein presenting the estimated time comprises presenting the estimated time as a countdown timer on the display of the microwave appliance.

8. The method of claim 7, wherein the countdown timer corresponds to the estimated time until the temperature of the article is less than the threshold temperature.

9. The method of claim 1, wherein:
measuring the temperature of the article with the infrared camera comprises taking a plurality of measured temperatures of the article with the infrared camera over time; and
calculating the estimated time comprises calculating the estimated time based at least in part on a cook time input, the plurality of measured temperatures of the article over time, and the current power setting of the microwave appliance.

10. A microwave appliance, comprising:
a cabinet defining a cooking chamber;
a user interface panel positioned on the cabinet, the user interface panel comprising a plurality of user inputs and a display;
an infrared camera mounted at the cabinet, the infrared camera operable to measure a temperature of an article in the cooking chamber of the cabinet; and
a controller operably coupled to the user interface panel and the infrared camera, the controller configured to receive a cook time input from the user interface panel, 502506US01/HUSA-1197 receive a measured temperature of the article in the cooking chamber from the infrared camera, calculate an estimated time until the temperature of the article in the cooking chamber is less than a threshold temperature based at least in part on the cook time input, the measured temperature of the article in the cooking chamber, and a current power setting of the microwave appliance, and present the estimated time on the display of the user interface panel.

11. The microwave appliance of claim 10, wherein the infrared camera is operable to measure an ambient temperature of the cooking chamber, and the controller is configured to calculate the estimated time based at least in part on the cook time input, the measured temperature of the article in the cooking chamber, the current power setting of the microwave appliance, and a measure ambient temperature of the cooking chamber.

12. The microwave appliance of claim 10, wherein the threshold temperature is no greater than forty-eight degrees Celsius or one hundred eighteen degrees Fahrenheit.

13. The microwave appliance of claim 10, wherein the controller is configured to receive the current power setting of the microwave appliance from the user interface panel.

14. The microwave appliance of claim 13, wherein the user interface panel is configured to output the current power setting of the microwave appliance in response to actuation of the plurality of user inputs.

15. The microwave appliance of claim 10, wherein the controller is configured to present the estimated time as a countdown timer on the display of the user interface panel. 502506US01/HUSA-1197

16. The microwave appliance of claim 15, wherein the countdown timer corresponds to the estimated time until the temperature of the article in the cooking chamber is less than the threshold temperature.

17. The microwave appliance of claim 10, wherein controller is configured to:
receive a plurality of measured temperatures of the article in the cooking chamber from the infrared camera over time; and
calculate the estimated time until the temperature of the article in the cooking chamber is less than the threshold temperature based at least in part on the cook time input, the plurality of measured temperatures of the article in the cooking chamber over time, and the current power setting of the microwave appliance.
